(19) United States
(12) Patent Application Publication
(10) Pub. No.: US 2012/0178663 A1
(43) Pub. Date: Jul. 12, 2012

(54) DISHWASHER DETERGENT

(75) Inventors: Dorota Sendor-Müller, Dusseldorf (DE); Johannes Zipfel, Dusseldorf (DE); Arnd Kessler, Monheim am Rhein (DE); Christian Nitsch, Dusseldorf (DE); Thorsten Bastigkeit, Wuppertal (DE)

(73) Assignee: Henkel AG & Co. KGaA, Dusseldorf (DE)

(21) Appl. No.: 13/418,645

(22) Filed: Mar. 13, 2012

Related U.S. Application Data
(63) Continuation of application No. PCT/EP2010/063177, filed on Sep. 8, 2010.

(30) Foreign Application Priority Data
Sep. 21, 2009 (DE) 10 2009 029 636.0

(51) Int. Cl. C11D 3/37

(52) U.S. Cl. 510/223; 510/229; 510/224

(57) ABSTRACT

A phosphate-free automatic dishwashing agent is described comprising from 0.05 to 20 wt. % amphoteric polymer and from 2 to 40 wt. % ethylene diamine disuccinic acid. The novel combination of amphoteric polymer with ethylene diamine disuccinic acid (EDDS) results in excellent performance compared to traditional phosphate-free automatic dishwashing agents, especially with regard to good cleaning, clear rinsing, and the overall inhibition of deposits.

### CROSS-REFERENCE TO RELATED APPLICATIONS

This application is a continuation of PCT Application Serial No. PCT/EP2010/063177, filed on Sep. 8, 2010, which claims priority under 35 U.S.C. §119 to 10 2009 029 636.0 (DE) filed on Sep. 21, 2009. The disclosures PCT/EP2010/063177 and DE 10 2009 029 636.0 are hereby incorporated by reference in their entirety.

### FIELD OF THE INVENTION

The present invention generally relates to detergents, and more particularly relates to automatic dishwashing agents, automatic dishwashing methods using these dishwashing agents and the use of these dishwashing agents to improve cleaning performance in automatic dishwashing.

### BACKGROUND OF THE INVENTION

Higher demands are often placed on machine-washed dishes than on manually washed dishes. For example, a dish that has been completely cleaned of food residues at first glance will still rate unsatisfactory if there is discoloration found after washing in the dishwasher. These remaining stains are possibly based on deposits of vegetable dyes on the surface of the dish.

To obtain spotless dishes, bleaching agents are used in automatic dishwashing agents. Automatic dishwashing agents usually also contain bleach activators or bleach catalysts in order to activate the bleaching agents and to achieve improved bleaching at temperatures of 60° C. or lower, temperatures where bleach catalysts have been proven to be especially effective.

There are limits to the use of bleaches based on incompatibilities with other wash-active or cleaning-active ingredients, such as enzymes, or based on stability problems during extended storage. This is especially true with liquid washing or cleaning agents.

One technical option for improving the cleaning performance of automatic dishwashing agents, in particular bleach-free automatic dishwashing agents, is to, increase the alkalinity of the composition. Thus, automatic dishwashing agents may contain builders as an essential ingredient to aid in successful cleaning and clear rinsing. Builders increase the alkalinity of the cleaning liquor, saponifying the fats and oils present, and they reduce the water hardness of the cleaning liquor by complexing the calcium ions present in the wash water. Alkali metal phosphates have proven to be especially effective builders, and for this reason they form the main ingredient of most commercially available automatic dishwashing agents.

Although phosphates are very valuable ingredients with regard to the performance benefits seen in automatic dishwashing agents, their use is not without problems. From an environmental standpoint, significant amounts of phosphate enters natural bodies of water via the household wastewater and plays an objectionable role in standing bodies of water (lakes, ponds) that become overfertilized. As a result of this phenomenon, also known as eutrophication, the use of pentasodium triphosphate in textile washing agents has been reduced substantially by law in some countries including The United States, Canada, Italy, Sweden, and Norway, and has been banned completely in Switzerland. Since 1984, washing agents in Germany are allowed to contain a maximum of 20% of this builder.

In addition to nitrilotriacetic acid, mainly sodium aluminosilicates (zeolites) are used as phosphate substitutes or replacements in textile washing agents. However, these substances are not suitable for use in automatic dishwashing agents for various reasons. Therefore, a number of substitutes are discussed in the literature as alternatives to alkali metal phosphates in automatic dishwashing agents, but the citrates are emphasized in particular.

Phosphate-free automatic dishwashing agents which also contain carbonates, bleaches and enzymes in addition to a citrate, are described in the European Patents EP 662 117 B1 (Henkel KGaA) and EP 692 020 B1 (Henkel KGaA).

Another alternative to the alkali metal phosphates, used alone or with citrates, is methyl glycine diacetic acid (MGDA). Automatic dishwashing agents that contain MGDA are described in the European Patent EP 906 407 B1 (Reckitt Benckiser) and in the European Patent Application EP 1 113 070 A2 (Reckitt Benckiser).

Despite previous efforts, the manufacturers of automatic dishwashing agents have not yet succeeded in providing phosphate-free automatic dishwashing agents that are superior or even comparable to the phosphate-containing cleaning agents with regard to their cleaning, clear rinse performance and residue-inhibiting performance. Equality in performance is a prerequisite for successful market introduction of phosphate-free cleaning agents. By far the majority of end consumers will always decide against an ecologically advantageous product despite broad public discussion if this product does not meet the market standard with regard to its price and/or performance.

Accordingly, it is desirable to develop phosphate-free automatic dishwashing agents that exhibit excellent performance in comparison with traditional phosphate-free automatic dishwashing agents with regard to deposits. Cleaning agents with an improved performance and a corresponding cleaning method are still needed in the industry. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

It has now been surprisingly found that a phosphate-free automatic dishwashing agent comprising a combination of amphoteric polymer with ethylene diamine disuccinic acid (EDDS) results in excellent performance in comparison with traditional phosphate-free automatic dishwashing agents, especially with regard to inhibiting deposits.

In an exemplary embodiment of the present invention, a phosphate-free automatic dishwashing agent comprises: (a) from 0.05 to 20 wt % of an amphoteric polymer; and (b) from 2 to 40 wt % ethylene diamine disuccinic acid.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The term “amphoteric polymer” herein refers to a polymer having negatively charged groups and/or monomer units in addition to a positively charged group in the polymer chain. These groups may be, for example, carboxylic acids, sulfonic acids or phosphonic acids.

Preferred amphoteric polymers have a monomer unit of the formula R¹R²C═CR³R⁴ in which each residue R¹, R², R³, R⁴ is independently selected from hydrogen, derivatized hydroxyl group, C₁₋₃₀ linear or branched alkyl groups, aryl, aryl-substituted C₁₋₃₀ linear or branched alkyl groups, polyalkoxylated alkyl groups, heteroatomic organic groups with at least one positive charge without charged nitrogen, at least one quaternized N atom or at least one amino group with a positive charge in the partial range of the pH from 2 to 11 or salts thereof, with the provision that at least one residue R¹, R², R³, R⁴ is a heteroatomic organic group with at least one positive charge without a charged nitrogen, at least one quaternized N atom or at least one amino group with a positive charge.

Especially preferred amphoteric polymers for use herein include at least one monomer having the general formula:

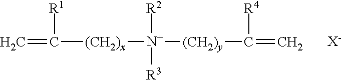

wherein R¹ and R⁴ are independently H or a linear or branched hydrocarbon residue with 1 to 6 carbon atoms; R² and R³ are independently an alkyl, hydroxyalkyl or aminoalkyl group in which the alkyl residue is linear or branched and has between 1 and 6 carbon atoms, (preferably a methyl group); x and y independently denote integers between 1 and 3; and X⁻ represents any counterion, but preferably a counterion chosen from the group consisting of chloride, bromide, iodide, sulfate, hydrogen sulfate, methosulfate, lauryl sulfate, dodecylbenzene sulfonate, p-toluene sulfonate (tosylate), cumene sulfonate, xylene sulfonate, phosphate, citrate, formate, acetate, and mixtures thereof.

Preferred residues R¹ and R⁴ in the above formula are selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)CH₂—CH₃, and —(CH₂CH₂—O)ₙH.

Amphoteric polymers having a cationic monomer unit of the general formula given above, in which R¹ and R⁴ stand for H, R² and R³ stand for methyl, and x and y are each 1, are most especially preferred.

An especially preferred monomer corresponds to the formula:

H₂C═CH—(CH₂)—N⁺(CH₃)₂—(CH₂)—CH═CH₂X⁻

wherein X− denotes chloride, and the substance is commonly known as DADMAC (diallyldimethylammonium chloride).

Additional especially preferred amphoteric polymers contain a monomer unit of the general formula:

R¹HC═CR²—C(O)—NH—(CH₂)ₓ—N⁺R³R⁴R⁵X⁻

wherein R¹, R², R³, R⁴ and R⁵ independently denote a linear or branched, saturated or unsaturated alkyl or hydroxyalkyl residue with 1 to 6 carbon atoms, and preferably a linear or branched alkyl residue selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)CH₂—CH₃ and —(CH₂CH₂—O)ₙH; and x denotes an integer between 1 and 6.

Within the scope of the present patent application, amphoteric polymers that comprise a cationic monomer unit of the general formula given above, in which R¹ is H; R², R³, R⁴ and R⁵ are methyl; and x is 3, are most especially preferred.

The corresponding monomer unit of the formula:

H₂C═C(CH₃)—C(O)—NH—(CH₂)ₓ—N⁺(CH₃)₃X⁻

is commonly known as MAPTAC (methacrylamidopropyl trimethylammonium chloride) when X− is chloride.

The preferred amphoteric polymers comprise at least one monomer selected from the group consisting of diallyl dimethylammonium salts, acrylamidopropyl trimethylammonium salts, and mixtures thereof.

The aforementioned amphoteric polymers not only comprise cationic groups but also anionic groups and/or monomer units. Such anionic monomer units originate from the group of linear or branched, saturated or unsaturated carboxylates, linear or branched, saturated or unsaturated phosphonates, linear or branched, saturated or unsaturated sulfates or linear or branched, saturated or unsaturated sulfonates. Preferred monomer units include acrylic acid, (meth)acrylic acid, (dimethyl) acrylic acid, (ethyl) acrylic acid, cyanoacrylic acid, vinyl acetic acid, allyl acetic acid, crotonic acid, maleic acid, fumaric acid, cinnamic acid and derivatives thereof, allylsulfonic acids, for example, allyloxybenzene sulfonic acid and methallylsulfonic acid or allylphosphonic acids.

Preferred amphoteric polymers that may be used are from the group of alkylacrylamide/acrylic acid copolymers, alkylacrylamide/methacrylic acid copolymers, alkylacrylamide/methyl methacrylic acid copolymers, alkylacrylamide/acrylic acid/alkylaminoalkyl(meth)acrylic acid copolymers, alkylacrylamide/methacrylic acid/alkylaminoalkyl(meth)acrylic acid copolymers, alkylacrylamide/methyl methacrylic acid/alkylaminoalkyl(meth)acrylic acid copolymers, alkylacrylamide/alkyl methacrylate/alkylaminoethyl methacrylate/alkyl methacrylate copolymers as well as the copolymers of unsaturated carboxylic acids, cationically derivatized, unsaturated carboxylic acids and optionally other ionic or nonionic monomers.

Amphoteric polymers that are preferably usable are obtained from the group of acrylamidoalkyltrialkylammonium chloride/acrylic acid copolymers and their alkali and ammonium salts, acrylamidoalkyltrialkylammonium chloride/methacrylic acid copolymers and their alkali and ammonium salts and methacroyl ethylbetaine/methacrylate copolymers.

In addition, amphoteric polymers, which encompass as the cationic monomers methacrylamido alkyltrialkylammonium chloride and dimethyl(diallyl)ammonium chloride in addition to one or more anionic monomers, are also preferred.

Especially preferred amphoteric polymers originate from the group of methacrylamidoalkyl trialkylammonium chloride/dimethyl(diallyl)ammonium chloride/acrylic acid copolymers, methacrylamidoalkyl trialkylammonium chloride/dimethyl(diallyl)ammonium chloride/methacrylic acid copolymers and methacrylamido alkyltrialkylammonium chloride/dimethyl(diallyl)ammonium chloride/alkyl(meth)acrylic acid copolymers as well as their alkali and ammonium salts.

Amphoteric polymers from the group of methacrylamidopropyl trimethylammonium chloride/dimethyl(diallyl)ammonium chloride/acrylic acid copolymers, methacrylamidopropyl trimethylammonium chloride/dimethyl (diallyl)ammonium chloride/acrylic acid copolymers and methacrylamidopropyl trimethylammonium chloride/dimethyl(diallyl)ammonium chloride/alkyl(meth)acrylic acid copolymers as well as their alkali and ammonium salts are preferred in particular.

The amount by weight of the amphoteric polymer in the total weight of the automatic dishwashing agents according to the invention is preferably 0.05 to 10 wt %, preferably 0.05 to 7 wt % and in particular 0.05 to 5 wt %.

The automatic dishwashing agents according to the invention contain ethylene diamine disuccinic acid (EDDS) as the second essential ingredient, and preferred automatic dishwashing agents are characterized in that the automatic dishwashing agent contains, based on its total weight, 3.0 to 35 wt %, preferably 4.0 to 30 wt % and in particular 8.0 to 25 wt % ethylene diamine disuccinic acid. Automatic dishwashing agents containing ethylene diamine disuccinic acid as a chelating agent are described in the International Patent Application WO 2006/029806 A1 (BASF).

The term “ethylene diamine disuccinic acid” (EDDS) also includes, in addition to the free acids, the salts thereof such as sodium or potassium salts. With respect to the amount by weight of ethylene diamine disuccinic acid used in the agents according to the invention, in use of the acid salt, the amount by weight of the free acid is to be relied on, in other words, the amount by weight of the salt must be converted to the amount by weight of the acid.

TABLE 1 below shows a few examples of recipes of preferred phosphate-free automatic dishwashing agents according to the invention.

TABLE 1
Preferred phosphate-free automatic dishwashing agents

| Ingredients | | | | |
|---|---|---|---|---|
| (wt. %) | Recipe 1 | Recipe 2 | Recipe 3 | Recipe 4 |
| Amphoteric | 0.05 to 10 | 0.05 to 7.0 | 0.05 to 5.0 | 0.05 to 5.0 |
| Polymer | | | | |
| (Acrylic acid/ | | | | |
| DADMAC | | | | |
| copolymer) | | | | |
| EDDS | 2.0 to 40 | 3.0 to 35 | 4.0 to 30 | 8.0 to 25 |
| Miscellaneous | Add 100 | Add 100 | Add 100 | Add 100 |

Preferred automatic dishwashing agents according to the invention have a low alkalinity and have a pH (10% solution, 20° C.) between 9 and 11.5, preferably between 9.5 and 11.5.

The automatic dishwashing agents according to the invention preferably contain additional builders but do not contain any phosphate.

A first group of builders that may be used are the inorganic builders, in particular the carbonates and silicates.

The use of carbonate(s) and/or bicarbonate(s), preferably alkali carbonate(s), is especially preferred, and sodium carbonate is especially preferred. Automatic dishwashing agents, characterized in that the automatic dishwashing agent contains, based on its total weight, 2.0 to 50 wt % (bi)carbonate, preferably 4.0 to 45 wt % (bi)carbonate, and in particular 8.0 to 40 wt % (bi)carbonate, are preferred according to the invention.

TABLE 2 below shows a few examples of recipes for preferred phosphate-free automatic dishwashing agents according to the invention.

TABLE 2
Preferred phosphate-free automatic dishwashing agents

| Ingredients | | | | |
|---|---|---|---|---|
| (wt. %) | Recipe 1 | Recipe 2 | Recipe 3 | Recipe 4 |
| (Bi)carbonate | 2.0 to 50 | 4.0 to 45 | 8.0 to 45 | 8.0 to 45 |
| Amphoteric | 0.05 to 10 | 0.05 to 7.0 | 0.05 to 5.0 | 0.05 to 5.0 |
| Polymer | | | | |
| (Acrylic acid/ | | | | |
| DADMAC | | | | |
| copolymer) | | | | |
| EDDS | 2.0 to 40 | 3.0 to 35 | 4.0 to 30 | 8.0 to 25 |
| Miscellaneous | Add 100 | Add 100 | Add 100 | Add 100 |

Crystalline sheet silicates such as amorphous silicates are included in the group of silicates that are preferred for use. However, automatic dishwashing agents according to the invention preferably do not contain any zeolites.

Crystalline sheet silicates of the general formula NaMSiₓO₂ₓ₊₁.yH₂O wherein M denotes sodium or hydrogen, x is a number from 1.9 to 22 preferably from 1.9 to 4, wherein preferred values for x are 2, 3 or 4, and y stands for a number from 0 to 33, preferably from 0 to 20, are preferred for use. The cleaning agents according to the invention preferably have an amount by weight of the crystalline sheet silicate of the formula NaMSiₓO₂ₓ₊₁.yH₂O of 0.1 to 20 wt %, preferably 0.2 to 15 wt % and in particular 0.4 to 10 wt %, each based on the total weight of these agents. With respect to the formation of deposits, it has proven advantageous to limit the amount by weight of silicate in the total weight of the automatic dishwashing agent. Preferred automatic dishwashing agents therefore contain less than 8.0 wt % silicate, especially preferably less than 6.0 wt % silicate and in particular less than 4.0 wt % silicate, i.e., between 0.1 and 4.0 wt % silicate, for example.

Amorphous sodium silicates with a Na₂O:SiO₂ modulus of 1:2 to 1:3.3, preferably from 1:2 to 1:2.8, and in particular from 1:2 to 1:2.6 may also be used.

TABLE 3 below shows a few examples of recipes for preferred phosphate-free automatic dishwashing agents according to the invention.

TABLE 3
Preferred phosphate-free automatic dishwashing agents

| Ingredients | | | | |
|---|---|---|---|---|
| (wt. %) | Recipe 1 | Recipe 2 | Recipe 3 | Recipe 4 |
| Silicate | 0.1 to 20 | 0.2 to 15 | 0.4 to 10 | 0.4 to 10 |
| Amphoteric | 0.05 to 10 | 0.05 to 7.0 | 0.05 to 5.0 | 0.05 to 5.0 |
| Polymer | | | | |
| (Acrylic acid/ | | | | |
| DADMAC | | | | |
| copolymer) | | | | |
| EDDS | 2.0 to 40 | 3.0 to 35 | 4.0 to 30 | 8.0 to 25 |
| Miscellaneous | Add 100 | Add 100 | Add 100 | Add 100 |

Citrate is an especially preferred ingredient of the agents according to the invention. The term “citrate” includes both citric acid and its salts, in particular its alkali metal salts. Especially preferred automatic dishwashing agents according to the invention contain citrate, preferably sodium citrate, in amounts of 12 to 50 wt %, preferably 15 to 40 wt % and in particular 15 to 30 wt %, each based on the total weight of the automatic dishwashing agent.

TABLE 4 below contains a few examples of recipes for preferred phosphate-free automatic dishwashing agents according to the invention.

TABLE 4
Preferred phosphate-free automatic dishwashing agents

| Ingredients | | | | |
|---|---|---|---|---|
| (wt. %) | Recipe 1 | Recipe 2 | Recipe 3 | Recipe 4 |
| Citrate | 12 to 50 | 12 to 50 | 15 to 40 | 15 to 30 |
| Carbonate | 5.0 to 50 | 10 to 45 | 10 to 45 | 20 to 40 |
| Amphoteric | 0.05 to 10 | 0.05 to 7.0 | 0.05 to 5.0 | 0.05 to 5.0 |
| Polymer | | | | |
| (Acrylic acid/ | | | | |
| DADMAC | | | | |
| copolymer) | | | | |
| EDDS | 2.0 to 40 | 3.0 to 35 | 4.0 to 30 | 8.0 to 25 |
| Miscellaneous | Add 100 | Add 100 | Add 100 | Add 100 |

Other usable organic builder substances include, for example, the polycarboxylic acids that may be used in the form of the free acid and/or their sodium salts, wherein polycarboxylic acids are understood to be carboxylic acids having more than one acid function. For example, these may include adipic acid, succinic acid, glutaric acid, malic acid, tartaric acid, maleic acid, fumaric acid, sugar acids, aminocarboxylic acids, nitrilotriacetic acid (NTA), if such a use is not objectionable for ecological reasons, as well as mixtures thereof. The free acids typically also have the property of an acidifying component in addition to their builder effect and therefore they are also used to adjust a lower and milder pH of the washing or cleaning agents. Succinic acid, glutaric acid, adipic acid, glucuronic acid and any mixtures thereof may be mentioned here in particular.

In addition to 1-hydroxyethane-1,1-diphosphonic acid, the chelating phosphonates include a number of different compounds, for example, diethylenetriamine penta(methylenephosphonic acid) (DTPMP). In this patent application in particular, hydroxyalkane phosphonates and/or aminoalkane phosphonates are preferred. Of the hydroxyalkane phosphonates, 1-hydroxyethane-1,1-diphosphonate (HEDP) is particularly important as a cobuilder. It is preferably used as a sodium salt; the disodium salt gives a neutral reaction and the tetrasodium salt gives an alkaline reaction (pH 9). Ethylene diamine tetramethylene phosphonate (EDTMP), diethylenetriamine pentamethylene phosphonate (DTPMP) and their higher homologs are preferably considered as the aminoalkane phosphonates. They are preferably used in the form of the neutral sodium salts, e.g., as hexasodium salt of EDTMP and/or as the hepta- and octasodium salts of DTPMP. HEDP is preferably used as a builder from the class of phosphonates. The aminoalkane phosphonates also have a pronounced heavy metal binding capacity. Accordingly, it may be preferable to use aminoalkane phosphonates, in particular DTPMP, or mixtures of the aforementioned phosphonates, in particular when the agents also contain bleaches.

Automatic dishwashing agents which contain 1-hydroxyethane-1,1diphosphonic acid (HEDP) or diethylenetriamine penta(methylenephosphonic acid) (DTPMP) as the phosphonates are especially preferred. The automatic dishwashing agents according to the invention may of course contain two or more different phosphonates. The amount by weight of phosphonates, relative to the total weight of the automatic dishwashing agents according to the invention, is preferably 1 to 8 wt %, preferably 1.2 to 6 wt % and in particular 1.5 to 4 wt %.

The residue-forming properties of the automatic dishwashing agents according to the invention were further improved by the addition of phosphonate. TABLE 5 below shows a few examples of recipes of preferred phosphate-free automatic dishwashing agents according to the invention.

TABLE 5
Preferred phosphate-free automatic dishwashing agents

| Ingredients | | | | |
|---|---|---|---|---|
| (wt. %) | Recipe 1 | Recipe 2 | Recipe 3 | Recipe 4 |
| Phosphonate | 1.0 to 8.0 | 1.2 to 6.0 | 1.2 to 6.0 | 1.5 to 4.0 |
| Amphoteric | 0.05 to 10 | 0.05 to 7.0 | 0.05 to 5.0 | 0.05 to 5.0 |
| Polymer | | | | |
| (Acrylic acid/ | | | | |
| DADMAC | | | | |
| copolymer) | | | | |
| EDDS | 2.0 to 40 | 3.0 to 35 | 4.0 to 30 | 8.0 to 25 |
| Miscellaneous | Add 100 | Add 100 | Add 100 | Add 100 |

Another group of organic builder substances is a group of polymers comprising monomers with sulfonic acid groups (and/or neutralized sulfonate groups). In addition to the sulfonic acid group monomers, these preferred polymers may also comprise unsaturated carboxylic acid monomers.

Preferred sulfonic acid group monomers that may be used to form the polymeric sulfonate include those of the formula, R⁵(R⁶)C═C(R⁷)—X—SO₃H, in which R⁵ to R⁷ independently of one another stand for —H, —CH₃, a linear or branched, saturated alkyl residue with 2 to 12 carbon atoms, a linear or branched mono- or polyunsaturated alkenyl residue with 2 to 12 carbon atoms, alkyl or alkenyl residues substituted with —NH₂, —OH or —COOH or stands for —COOH or —COOR⁴ wherein R⁴ is a saturated or unsaturated linear or branched hydrocarbon residue with 1 to 12 carbon atoms and X is an optional spacer group selected from —(CH₂)ₙ wherein n=0 to 4, —COO—(CH₂)ₖ wherein k=1 to 6, —C(O)—NH—C(CH₃)₂—, —C(O)—NH—C(CH₃)₂—CH₂— and —C(O)—NH—CH(CH₂CH₃)—.

Of these, the preferred monomers are selected from the group consisting of:

H₂C═CH—X—SO₃H,

H₂C═C(CH₃)—X—SO₃H,

HO₃S—X—(R⁶)C═C(R⁷)—X—SO₃H,

and mixtures thereof, wherein R⁶ and R⁷ independently of one another are selected from —H, CH₃, —CH₂CH₃, —CH₂CH₂CH₃, —CH(CH₃)₂ and X stands for a spacer group which is optionally present and is selected from (CH₂)ₙ wherein n=0 to 4, —COO—(CH₂)ₖ wherein k=1 to 6, —C(O)—NH—C(CH₃)₂—, —C(O)—NH—C(CH₃)₂— and C(O)—NH—CH(CH₂CH₃)—.

Especially preferred sulfonic acid group monomers include 1-acrylamido-1-propanesulfonic acid, 2-acrylamido-2-propanesulfonic acid, 2-acrylamino-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzene sulfonic acid, methallyloxybenzene sulfonic acid, 2-hydroxy-3-(2-propenyloxy)propane sulfonic acid, 2-methyl-2-propene-1-sulfonic acid, styrene sulfonic acid, vinyl sulfonic acid, 3-sulfopropylacrylate, 3-sulfopropyl methacrylate, sulfo-methacrylamide, sulfomethyl methacrylamide, and mixtures thereof, and any water-soluble salts thereof.

The sulfonic acid groups in these sulfonate polymers may be present partially or entirely in neutralized form, i.e., the acidic hydrogen atom of the sulfonic acid group in some or all of the sulfonic acid groups may be replaced with metal ions, preferably alkali metal ions and in particular sodium ions. The use of partially or fully neutralized copolymers containing sulfonic acid groups is preferred according to the invention.

Preferred unsaturated carboxylic acid monomers that may be included are unsaturated carboxylic acids of the formula R¹(R²)C═C(R³)COOH in which R¹ to R³ independently of one another stand for —H, —CH₃, a linear or branched, saturated alkyl residue with 2 to 12 carbon atoms, a linear or branched mono- or polyunsaturated alkenyl residue with 2 to 12 carbon atoms, alkyl or alkenyl residues substituted with —NH₂, —OH or —COOH as defined above or stands for —COOH or —COOR⁴ wherein R⁴ is a saturated or unsaturated, linear or branched hydrocarbon residue with 1 to 12 carbon atoms.

Especially preferred unsaturated carboxylic acids include acrylic acid, methacrylic acid, ethacrylic acid, α-chloroacrylic acid, α-cyanoacrylic acid, crotonic acid, α-phenylacrylic acid, maleic acid, maleic anhydride, fumaric acid, itaconic acid, citraconic acid, methylene malonic acid, sorbic acid, cinnamic acid, or mixtures thereof. The unsaturated dicarboxylic acids may of course also be used.

When the sulfonate polymers comprise both sulfonate group monomers and carboxylic acid group monomers, the monomer distribution in these polymers is preferably 5 to 95 wt. % unsaturated sulfonic acid monomers and 10 to 50 wt. % unsaturated carboxylic acid monomers. It is especially preferred that the monomer distribution is 50-90 wt. % unsaturated sulfonic acid monomers and 10-50 wt. % unsaturated carboxylic acid monomers. These preferred weight percentages of monomers are based on the total weight of the sulfonate polymer (not total weight of agent composition).

The molecular weight of the sulfonate copolymers preferred for use according to the invention may be varied to adapt the properties of the polymers to the desired intended purpose. Preferred automatic dishwashing agents are characterized in that the copolymers have molecular weights of 2,000 to 200,000 gmol⁻¹, preferably from 400 to 25,000 gmol⁻¹, and in particular, from 5,000 to 15,000 gmol⁻¹.

In another preferred embodiment, the polymer sulfonates may also comprise at least one nonionic, preferably hydrophobic monomer. The use of a more hydrophobic polymer improves the clear rinsing performance of the automatic dishwashing agents herein.

Preferred nonionic monomers are of the general formula R¹(R²)C═C(R³)—X—R⁴ in which R¹ to R³ independently denote —H, —CH₃ or —C₂H₅; X represents a spacer group that is optionally present and selected from the group CH₂, —C(O)O— and —C(O)—NH—; and, R⁴ denotes a linear or branched, saturated alkyl residue with 2 to 22 carbon atoms or for an unsaturated, preferably aromatic, residue with 6 to 22 carbon atoms.

Especially preferred nonionic monomers are selected from the group consisting of butene, isobutene, pentene, 3-methylbutene, 2-methylbutene, cyclopentene, hexane, 1-hexane, 2-methyl-1-pentene, 3-methyl-1-pentene, cyclohexene, methyl cyclopentene, cycloheptene, methyl cyclohexene, 2,4,4-trimethyl-1-pentene, 2,4,4-trimethyl2-pentene, 2,3-dimethyl-1-hexene, 2,4-dimethyl-1-hexene, 2,5-dimethyl-1hexene, 3,5-dimethyl-1-hexene, 4,4-dimethyl-1-hexane, ethyl cyclohexyne, 1-octene, α-olefins with 10 or more carbon atoms, such as 1-decene, 1-dodecene, 1-hexadecene, 1-octadecene and C₂₂-α-olefin, 2-styrene, α-methylstyrene, 3-methylstyrene, 4-propylstyrene, 4-cyclohexylstyrene, 4-dodecylstyrene, 2-ethyl-4-benzylstyrene, 1-vinylnaphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid 2-ethylhexyl ester, methacrylic acid 2-ethylhexyl ester, N-(2-ethylhexyl) acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester, N-(behenyl)acrylamide, and mixtures thereof.

Preferred automatic dishwashing agents in accordance with the present invention may also comprise an anionic polymer comprising: (i) mono- or polyunsaturated monomers from the group of carboxylic acids; (ii) mono- or polyunsaturated monomers from the group of sulfonic acids; and (iii) optionally additional ionic and/or nonionic monomers. The amount by weight of these polymers in the total weight of the automatic dishwashing agent is preferably 2.0 to 20 wt %, preferably 2.5 to 15 wt % and in particular 2.5 to 10 wt %.

TABLE 6 shows a few examples of preferred phosphate-free automatic dishwashing agents according to the invention wherein the anionic polymer for each of the four recipes comprises (i) mono- or polyunsaturated monomers from the group of carboxylic acids; (ii) mono- or polyunsaturated monomers from the group of sulfonic acids; and (iii) optionally additional nonionic monomers.

TABLE 6
Preferred phosphate-free automatic dishwashing agents

| Ingredients | | | | |
|---|---|---|---|---|
| (wt. %) | Recipe 1 | Recipe 2 | Recipe 3 | Recipe 4 |
| Anionic | 2.0 to 20 | 2.5 to 15 | 2.5 to 15 | 2.5 to 10 |
| polymer | | | | |
| Amphoteric | 0.05 to 10 | 0.05 to 7.0 | 0.05 to 5.0 | 0.05 to 5.0 |
| Polymer | | | | |
| (Acrylic acid/ | | | | |
| DADMAC | | | | |
| copolymer) | | | | |
| EDDS | 2.0 to 40 | 3.0 to 35 | 4.0 to 30 | 8.0 to 25 |
| Miscellaneous | Add 100 | Add 100 | Add 100 | Add 100 |

Preferred automatic dishwashing agents also contain surfactants, preferably nonionic and/or amphoteric surfactants.

It has surprisingly been found that the melting points of the nonionic surfactants used in the surfactant system according to the invention affect the formation of deposits in automatic dishwashing. The prerequisite for this technical effect is, among other things, that at least one of the surfactants used has a melting point above 25° C. Preferred nonionic surfactants for inclusion in the present automatic dishwashing agents are those having a melting point above 28° C. and preferably above 31° C.

The amount by weight of the nonionic surfactant, relative to the total weight of the automatic dishwashing agent, is preferably 0.1 to 15 wt %, preferably 0.2 to 10 wt %, especially preferably 0.5 to 8 wt %, and in particular 1.0 to 6 wt %.

In addition to the factors mentioned above, the residue inhibiting effect of the automatic dishwashing agents according to the invention is also influenced by the structure of the nonionic surfactants used. Especially convincing results are achieved with regard to the inhibition of deposits when using end group-capped nonionic surfactants from the group of hydroxy mixed ethers. These nonionic surfactants have proven to be superior to the other known nonionic surfactants from the state of the art.

Another preferred ingredient of the automatic dishwashing agents according to the invention is nonionic surfactants of the general formula:

R¹—CH(OH)CH₂O-(AO)_{w}-(A′O)ₓ-(A″O)_{y}-(A′″O)_{z}—R²

wherein R¹ and R² denote a C₂₋₂₆ alkyl residue; A, A′, A″ and A″′ independently denote a residue selected from the group of —CH₂CH₂, —CH₂CH₂—CH₂, —CH₂CH(CH₃), —CH₂—CH₂—CH₂—CH₂, CH₂—CH₂—CH₂—CH₂, —CH₂—CH(CH₃)—CH₂—, and —CH₂—CH(CH₂—CH₃); and w, x, y and z denote values between 0.5 and 120, wherein x, y and/or z may also be 0.

Automatic dishwashing agents according to the invention, in which at least one of the nonionic surfactants has the aforementioned general formula, are preferred because of their better residue profile.

In particular those end group-capped polyoxyalkylated nonionic surfactants which also have a linear or branched, saturated or unsaturated, aliphatic or aromatic hydrocarbon residue R² with 1 to 30 carbon atoms, wherein x stands for values between 1 and 90, preferably for values between 30 and 80 and in particular for values between 30 and 60 according to the formula R¹O[CH₂CH₂O]ₓCH₂CH(OH)R² in addition to a residue R¹ which stands for linear or branched, saturated or unsaturated, aliphatic or aromatic hydrocarbon residues with 2 to 30 carbon atoms, preferably with 4 to 22 carbon atoms.

Especially preferred are the surfactants of the formula R¹O[CH₂CH(CH₃)O]ₓ[CH₂CH₂O]_{y}CH₂CH(OH)R², in which R¹ denotes a linear or branched aliphatic hydrocarbon residue with 4 to 18 carbon atoms or mixtures thereof; R² denotes a linear or branched hydrocarbon residue with 2 to 26 carbon atoms or mixtures thereof; x stands for values between 0.5 and 1.5; and, y stands for a value of at least 15.

The group of these nonionic surfactants includes, for example, the C₂₋₂₆ fatty alcohol (PO)₁-(EO)₁₅₋₄₀-2-hydroxyalkyl ethers, in particular also the C₈₋₁₀ fatty alcohol (PO)₁-(EO)₂₂-2-hydroxydecyl ethers.

In addition those end group-capped polyoxyalkylated nonionic surfactants of the formula R¹O[CH₂CH₂O]ₓ[CH₂CH(R³)O]_{y}CH₂CH(OH)R², in which R¹ and R² independently of one another stand for a linear or branched, saturated or mono- and polyunsaturated hydrocarbon residue with 2 to 26 carbon atoms, R³ independently of one another is selected from —CH₃, —CH₂CH₃, CH₂CH₂—CH₃, —CH(CH₃)₂, but preferably stands for —CH₃, and x and y independently of one another stand for values between 1 and 32, wherein nonionic surfactants in which R³=—CH₃ and values for x are from 15 to 32 and y are from 0.5 and 1.5 are most especially preferred.

Additional nonionic surfactants preferred for use here include the end group-capped polyoxyalkylated nonionic surfactants of the formula R¹O[CH₂CH(R³)O]ₓ[CH₂]ₖCH(OH)[CH₂]ⱼOR² in which R¹ and R² stand for linear or branched, saturated or unsaturated aliphatic or aromatic hydrocarbon residues with 1 to 30 carbon atoms, R³ stands for H or a methyl, ethyl, n-propyl, isopropyl, n-butyl, 2-butyl or 2-methyl-2-butyl residue, x stands for values between 1 and 30, k and j stand for values between 1 and 12, preferably between 1 and 5. When the value x≧2, then any R³ in the above formula R¹O[CH₂CH(R³)O]ₓ[CH₂]ₖCH(OH)[CH₂]ⱼOR² may be different. R¹ and R² are preferably linear or branched, saturated or unsaturated, aliphatic or aromatic hydrocarbon residues with 6 to 22 carbon atoms, wherein residues with 8 to 18 carbon atoms are especially preferred. For the residue R³, H, CH₃ or CH₂CH₃ is especially preferred. Especially preferred values for x are in the range from 1 to 20, in particular from 6 to 15.

As described above, each R³ in the formula given above may be different, if x≧2. The alkylene oxide unit in the brackets may be varied in this way. For example, if x stands for 3, then the R³ residue may be selected to form ethylene oxide (R³=H) units or propylene oxide (R³=CH₃) units, which may be joined to one another in any order, for example (EO)(PO)(EO), (EO)(EO)(PO), (EO)(EO)(EO), (PO)(EO)(PO), (PO)(PO)(EO) and (PO)(PO)(PO). The value 3 for x has been selected as an example and may readily be larger, in which case the range of variation increased with increasing x values and includes, for example, a large number of (EO) groups combined with a small number of (PO) groups or vice versa.

Especially preferred end group-capped polyoxyalkylated alcohols of the formula given above have values of k=1 and j=1, so that the formula given above is simplified to R¹O[CH₂CH(R³)O]ₓCH₂CH(OH)CH₂OR². In the latter formula, R¹, R² and R³ are defined as above, and x stands for numbers from 1 to 30, preferably from 1 to 20 and in particular from 6 to 18. Surfactants in which the residues R¹ and R² have 9 to 14 carbon atoms, wherein R³ stands for H and x assumes values of 6 to 15 are especially preferred.

Finally, nonionic surfactants of the general formula R¹—CH(OH)CH₂O-(AO)_{w}—R² have proven to be especially effective, wherein R¹ denotes a linear or branched, saturated or mono- and/or polyunsaturated C₆₋₂₄ alkyl or alkenyl residue; R² denotes a linear or branched hydrocarbon residue with 2 to 20 carbon atoms; A denotes a residue selected from the group CH₂CH₂, —CH₂CH₂—CH₂, —CH₂—CH(CH₃); and w stands for values between 10 and 120, preferably 10 to 80, in particular 20 to 40.

For example, the C₄₋₂₂ fatty alcohol (EO)₁₀₋₈₀-2-hydroxyalkyl ether, in particular also the C₈₋₁₂ fatty alcohol (EO)₂₂-2-hydroxydecyl ether and C₄₋₂₂ fatty alcohol-(EO)₄₀₋₈₀-2-hydroxyalkyl ether belong to this group of nonionic surfactants.

Preferred automatic dishwashing agents according to the invention are free of anionic surfactants.

TABLE 7 shows a few examples of recipes for preferred phosphate-free automatic dishwashing agents according to the invention.

TABLE 7
Preferred phosphate-free automatic dishwashing agents

| Ingredients | | | | |
|---|---|---|---|---|
| (wt. %) | Recipe 1 | Recipe 2 | Recipe 3 | Recipe 4 |
| Amphoteric | 0.05 to 10 | 0.05 to 7.0 | 0.05 to 5.0 | 0.05 to 5.0 |
| Polymer | | | | |
| (Acrylic acid/ | | | | |
| DADMAC | | | | |
| copolymer) | | | | |
| EDDS | 2.0 to 40 | 3.0 to 35 | 4.0 to 30 | 8.0 to 25 |
| Alcohol ethoxylate nonionic surfactant: | 0.1 to 15 | 0.2 to 10 | 0.5 to 8.0 | 1.0 to 6.0 |
| C₄₋₂₂ -(EO)₁₀₋₈₀-2-hydoxyalkyl ether | | | | |
| Miscellaneous | Add 100 | Add 100 | Add 100 | Add 100 |

In addition to the polymers, builders and nonionic surfactants described above, the automatic dishwashing agents according to the invention preferably contain additional washing-active and cleaning-active ingredients, in particular active ingredients from the group of enzymes, bleaching agents, bleach activators and bleach catalysts, corrosion inhibitors, glass corrosion inhibitors, scents or dyes.

Automatic dishwashing agents according to the invention may contain enzyme(s) as an additional ingredient. These include in particular proteases, amylases, lipases, hemicellulases, cellulases, perhydrolases or oxidoreductases as well as preferably the mixtures thereof. These enzymes are of natural origin in principle. Starting from the natural molecules, improved variants are available for use in washing or cleaning agents, and are preferably used accordingly. Washing or cleaning agents preferably contain enzymes in total amounts of 1×10⁻⁶ to 5 wt %, based on active protein. The protein concentration may be determined with the help of known methods, for example, the BCA method or the biuret method. Especially preferred automatic dishwashing agents also contain enzyme(s), preferably protease and/or amylase, in particular amylase.

Of the proteases, those of the subtilisin type are preferred. Examples include the subtilisins BPN′ and Carlsberg s well as their further developed forms, protease PB92, the subtilisins 147 and 309, the alkaline protease from Bacillus lentos, subtilisin DY and the enzymes thermitase, proteinase K and proteases TW3 and TW7, which can be assigned to the subtilases but not to the subtilisins in the narrower sense.

Examples of amylases that may be used according to the invention include the α-amylases from Bacillus licheniformis, from B. amyloliquefaciens, from B. stearothermophilus, from Aspergillus niger and A. oryzae as well as the further developments of the aforementioned amylases, which have been improved for use in washing and cleaning agents. In addition the α-amylase from Bacillus sp. A 7-7 (DSM 12368) and the cyclodextrin glucanotransferase (CGTase) from B. agaradherens (DSM 9948) are to be emphasized for this purpose.

In addition, lipases or cutinases can also be used according to the invention, in particular because of their triglyceride-cleaving activities but also in order to create peracids in situ from suitable precursors. These include, for example, the lipases that can be obtained originally from Humicola lanuginose (Thermomyces lanuginosus) and/or further developed lipases, in particular those with the amino acid exchange D96L.

In addition, enzymes which may be combined under the term “hemicellulases” may also be used. These include, for example, mannanases, xanthan lyases, pectin lyases (=pectinases), pectin esterases, pectate lyases, xyloglucanases (=xylanases), pullulanases and β-glucanases.

To increase the bleaching effect, oxidoreductases, for example, oxidases, oxygenases, catalases, peroxidases such as halo-, chloro-, bromo-, lignin, glucose or manganese peroxidases, dioxygenases or laccases (phenol oxidases, polyphenol oxidases) may be used according to the invention to increase the bleaching effect. In addition, preferably organic, especially preferably aromatic compounds which interact with the enzymes are advantageously also added to enhance the activity of the respective oxidoreductases (enhancers) or to ensure the electron flow when there is a greater difference in redox potentials between the oxidizing enzymes and the soiling (mediators).

A preferred automatic dishwashing agent according to the invention is characterized in that the automatic dishwashing agent contains, based on its total weight, enzyme preparation(s) in amounts of 0.1 to 12 wt %, preferably from 0.2 to 10 wt % and in particular from 0.5 to 8 wt %.

Washing or cleaning agents may contain stabilizers to stabilize proteins and/or enzymes during storage, such as against damage from inactivation, denaturing, decomposition, oxidation, or proteolytic cleavage. Inhibition of proteolysis is often preferable, in particular when the agents contain proteases and when the proteins and/or enzymes are produced microbially.

Washing or cleaning active proteases and amylases are not usually supplied in the form of the pure protein but instead are supplied in the form of stabilized preparations suitable for storage and shipping. These prefabricated preparations include, for example, the solid preparations obtained by granulation, extrusion of lyophilization or in particular in the case of liquid or gelatinous agents, solutions of the enzymes, advantageously with the highest possible concentration, a low water content and/or mixed with stabilizers or other auxiliary agents.

As can be seen from the previous discussion, the enzyme protein forms only a fraction of the total weight of the usual enzyme preparations. Protease and amylase preparations preferred for use according to the invention contain between 0.1 and 40 wt %, preferably between 0.2 and 30 wt %, especially preferably between 0.4 and 20 wt % and in particular between 0.8 and 10 wt % of the enzyme protein.

TABLE 8 shows a few examples of recipes of preferred phosphate-free automatic dishwashing agents according to the invention.

TABLE 8
Preferred phosphate-free automatic dishwashing agents

| Ingredients | | | | |
|---|---|---|---|---|
| (wt. %) | Recipe 1 | Recipe 2 | Recipe 3 | Recipe 4 |
| Amphoteric | 0.05 to 10 | 0.05 to 7.0 | 0.05 to 5.0 | 0.05 to 5.0 |
| Polymer | | | | |
| (Acrylic acid/ | | | | |
| DADMAC | | | | |
| copolymer) | | | | |
| EDDS | 2.0 to 40 | 3.0 to 35 | 4.0 to 30 | 8.0 to 25 |
| Enzyme | 0.1 to 12 | 0.2 to 10 | 0.2 to 10 | 0.5 to 8.0 |
| preparation | | | | |
| Miscellaneous | Add 100 | Add 100 | Add 100 | Add 100 |

Automatic dishwashing agents according to the invention may also comprise a bleaching agent, wherein oxygen bleaching agents are preferred. Of the compounds which supply H₂O₂ in water and serve as bleaching agents, sodium percarbonate, sodium perborate tetrahydrate and sodium perborate monohydrate are especially important. Additional bleaching agents that can be used include, for example, peroxypyrophosphates, citrate perhydrates as well as peracid salts or peracids, which supply H₂O₂, such as perbenzoates, peroxophthalates, diperazelaic acid, phthaloimino peracid or diperdodecanedioic acid.

In addition, bleaching agents from the group of organic bleaching agents may also be used. Typical organic bleaching agents include the diacyl peroxides, for example, dibenzoyl peroxide. Other typical organic bleaching agents include the peroxy acids, the alkylperoxy acids and the arylperoxy acids being mentioned in particular as examples.

Preferred automatic dishwashing agents according to the invention are characterized in that they contain an oxygen bleaching agent, preferably sodium percarbonate, especially preferably a coated sodium percarbonate. The amount by weight of the bleaching gent based on the total weight of the washing or cleaning agent is between 2.0 and 30 wt %, preferably between 4.0 and 20 wt % and in particular between 6.0 and 15 wt % in preferred embodiments.

TABLE 9 shows a few examples of recipes of preferred phosphate-free automatic dishwashing agents according to the invention.

TABLE 9
Preferred phosphate-free automatic dishwashing agents

| Ingredients | | | | |
|---|---|---|---|---|
| (wt. %) | Recipe 1 | Recipe 2 | Recipe 3 | Recipe 4 |
| Amphoteric | 0.05 to 10 | 0.05 to 7.0 | 0.05 to 5.0 | 0.05 to 5.0 |
| Polymer | | | | |
| (Acrylic acid/ | | | | |
| DADMAC | | | | |
| copolymer) | | | | |
| EDDS | 2.0 to 40 | 3.0 to 35 | 4.0 to 30 | 8.0 to 25 |
| Sodium | 2.0 to 30 | 4.0 to 20 | 4.0 to 20 | 4.0 to 20 |
| percarbonate | | | | |
| Miscellaneous | Add 100 | Add 100 | Add 100 | Add 100 |

The automatic dishwashing agents according to the invention may also contain bleach activators. These compounds yield aliphatic peroxycarboxylic acids, preferably 1 to 10 carbon atoms, in particular 2 to 4 carbon atoms and/or optionally substituted perbenzoic acid under perhydrolysis conditions. Substances having O- and/or N-acyl groups of the aforementioned number of carbon atoms and/or optionally substituted benzoyl groups are suitable. Polyacylated alkylenediamines are preferred, and tetraacetyl ethylene diamine (TAED) has proven to be especially suitable. These bleach activators, in particular TAED, are preferably used in amounts of up to 10 wt %, in particular 0.1 wt % to 10 wt %, especially 0.5 to 8 wt %, and especially preferably 1.0 to 6 wt %.

In addition, or as an alternative to conventional bleach activators, the automatic dishwashing agents may comprise bleach potentiating transition metal salts and/or transition metal complexes, such as Mn—, Fe—, Co—, Ru— or Mo-salene complexes or carbonyl complexes. Mn, Fe, Co, Ru, Mo, Ti, V and Cu complexes with tripod ligands containing N and Co, Fe, Cu and Ru amine complexes may be used as bleach catalysts.

Complexes of manganese in the oxidation stage II, III, IV or IV, preferably containing one or more macrocyclic ligand(s) with the donor functions N, NR, PR, O and/or S are especially preferred. Ligands having nitrogen donor functions are preferred for use. In the agents according to the invention, it is especially preferred to use bleach catalyst(s), which contain as macromolecular ligands 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN) and/or 2-methyl-1,4,7-triazacyclononane (Me/TACN). Suitable manganese complexes include, for example, [Mn^{III}₂(μ-(O)₁(μ-OAc)₂](ClO₄)₂, [Mn^{III}Mn^{IV}(μ-O)₂-(μ-OAc)₁(TACN)₂](BPh₄)₂, [Mn^{IV}₄(μ-O)₆(TACN)₄](ClO₄)₄, [Mn^{III}₂(μ-O)₁(μ-OAc)₂(Me-TACN)₂](ClO₄)₂, [Mn^{III}Mn^{IV}(μ-O)₁(μ-OAc)₂(Me-TACN)₂](ClO₄)₃, [Mn^{IV}₂(μ-O)₃(Me-TACN)₂](PF₆)₂ and [Mn^{IV}₂(μ-O)₃(Me/Me-TACN)₂](PF₆)₂(OAc═OC(O)CH₃).

Automatic dishwashing agents, characterized in that they also contain a bleach catalyst selected from the group of bleach potentiating transition metal salts and transition metal complexes, preferably from the group of complexes of manganese with 1,4,7-trimethyl-1,4,7-triazacyclononane (Me₃-TACN) or 1,2,4,7-tetramethyl-1,4,7-triazacyclononane (Me₄-TACN), are preferred according to the invention because the cleaning result can be improved significantly by the aforementioned bleach catalyst.

The aforementioned bleach potentiating transition metal complexes in particular with the central atoms Mn and Co are used in the usual amounts, preferably in an amount of up to 5 wt %, in particular of 0.0025 wt % to 1 wt % and especially preferably from 0.01 wt % to 0.30 wt %, each based on the total weight of the agent containing the bleach catalyst. In special cases, however, more bleach catalyst may also be used.

TABLE 10 shows a few examples of recipes of preferred phosphate-free automatic dishwashing agents according to the invention.

TABLE 10
Preferred phosphate-free automatic dishwashing agents

| Ingredients | | | | |
|---|---|---|---|---|
| (wt. %) | Recipe 1 | Recipe 2 | Recipe 3 | Recipe 4 |
| Citrate | 12 to 50 | 12 to 50 | 15 to 40 | 15 to 30 |
| Carbonate | 5.0 to 50 | 10 to 45 | 10 to 45 | 20 to 40 |
| Phosphonate | 1.0 to 8.0 | 1.2 to 6.0 | 1.2 to 6.0 | 1.5 to 4.0 |
| Amphoteric | 0.05 to 10 | 0.05 to 7.0 | 0.05 to 5.0 | 0.05 to 5.0 |
| Polymer | | | | |
| (Acrylic acid/ | | | | |
| DADMAC | | | | |
| copolymer) | | | | |
| EDDS | 2.0 to 40 | 3.0 to 35 | 4.0 to 30 | 8.0 to 25 |
| Alcohol ethoxylate nonionic surfactant: | 0.5 to 80 | 1.0 to 80 | 2.0 to 7.0 | 2.0 to 7.0 |
| C₄₋₂₂ -(EO)₁₀₋₈₀-2-hydoxyalkyl ether | | | | |
| Enzyme preparation | 0.1 to 12 | 0.2 to 10 | 0.2 to 10 | 0.5 to 8.0 |
| Sodium percarbonate | 2.0 to 30 | 4.0 to 20 | 4.0 to 20 | 4.0 to 20 |
| Miscellaneous | Add 100 | Add 100 | Add 100 | Add 100 |

The automatic dishwashing agents according to the invention may be present in fabricated forms with which the skilled person is familiar, i.e., for example, in solid or liquid form, but also as a combination of solid and liquid forms.

Suitable solid forms include in particular powders, granules, exudates or compacted forms, in particular tablets. The liquid forms based on water and/or organic solvents may be thickened, in the form of gels.

If they are fabricated in liquid form, preferred automatic dishwashing agents according to the invention have a water content of 20 to 70 wt %, preferably 30 and 60 wt % and in particular 35 and 55 wt %, based on the total weight of the agent.

Agents according to the invention may be fabricated as single-phase products or multiphase products. Automatic dishwashing agents having one, two, three or four phases are preferred in particular. Automatic dishwashing agents, characterized in that they are present in the form of a prefabricated dosing unit having two or more phases are especially preferred.

The individual phases of multiphase agents may have the same or different aggregate states. Automatic dishwashing agents containing at least two different solid phases and/or at least two liquid phases and/or at least one solid phase and at least one liquid phase are preferred in particular. Two-phase or multiphase tablets, for example, two-layer tablets, in particular two-layer tablets with a hollow depression and a molded body in the depression are especially preferred.

Automatic dishwashing agents preferred according to the invention are in the form of a tablet, preferably in the form of multilayer tablet.

Automatic dishwashing agents according to the invention are preferably prefabricated to dosing units. These dosing units preferably encompass the amount of washing or cleaning-active substance required for one cleaning cycle. Preferred dosing units have a weight between 12 and 30 g, preferably between 14 and 26 g and in particular between 15 and 22 g.

The volume of the aforementioned dosing units and also their three-dimensional shape are selected so that the ability of the prefabricated units to be dosed through the dosing chamber of a dishwasher is ensured. The volume of the dosing unit is therefore preferably between 10 and 35 mL, preferably between 12 and 30 mL and in particular between 15 and 25 mL.

The automatic dishwashing agents according to the invention, in particular the prefabricated dosing units, preferably have a water-soluble coating.

To facilitate the disintegration of prefabricated molded bodies, it is possible to incorporate disintegration aids, so-called tablet disintegrants, into these agents to shorten the disintegration time.

These substances, which are also known as “disintegrants” based on their effect, increase their volume on contact with water, which increases the inherent volume on the one hand (swelling) but also a pressure can be created through the release of gases, causing the tablet to disintegrate into smaller particles. The old familiar disintegration aids include, for example, carbonate/citric acid systems, but other organic acids may also be used. Swelling disintegration aids include, for example, synthetic polymers such as polyvinylpyrrolidone (PVP) or natural polymers and/or modified natural substances such as cellulose and starch and their derivatives or alginates or casein derivatives.

Disintegration aids in amounts of 0.5 to 10 wt %, preferably 3 to 7 wt % and in particular 4 to 6 wt %, each based on the total weight of the agent containing the disintegration aid, are preferably used.

Disintegration agents based on cellulose are used as the preferred disintegrants, so that preferred washing or cleaning agents contain such a disintegrant, based on cellulose in amounts of 0.5 to 10 wt %, preferably 3 to 7 wt % and in particular 4 to 6 wt %. The cellulose used as a disintegrant is preferably not used in finely divided form, but instead it is converted to a coarser form, for example, by granulating or compacting, before being added to the premixes to be pressed. The particle sizes of such disintegrants are usually greater than 200 μm, preferably at least 90 wt % being between 300 and 1600 μm and in particular at least 90 wt % being between 400 and 1200 μm.

Preferred disintegration aids, preferably a disintegration aid based on cellulose, preferably in granular, co-granulated or compacted form, are contained in the agents containing the disintegrant in amounts of 0.5 to 10 wt %, preferably from 3 to 7 wt % and in particular from 4 to 6 wt %, each based on the total weight of the agent containing the disintegrant.

In addition effervescent systems which release gases may also preferably be used as tablet disintegration aids according to the invention. Preferred effervescent systems, however, consist of at least two ingredients which react with one another to form a gas, for example, alkali metal carbonate and/or bicarbonate and an acidifying agent, which is suitable for releasing carbon dioxide from the alkali metal salts in aqueous solution. An acidifying agent which releases carbon dioxide from the alkali salts in aqueous solution is citric acid, for example.

The active ingredient combinations described above is suitable in particular for cleaning dishes in automatic dishwashing methods. Another subject of the present patent application is a method for cleaning dishes in a dishwashing machine using an automatic dishwashing agent according to the invention, wherein the automatic dishwashing agent is preferably dosed into the interior of a dishwasher during its run through a dishwashing program, before the start of the main rinse cycle or in the course of the main rinse cycle. The dosing, i.e., the addition of the agent according to the invention to the interior of the dishwasher may take place manually, but the agent is preferably dosed into the interior of the dishwasher by means of the dosing chamber of the dishwasher. In the course of the cleaning process, preferably no additional water softener and no additional clear rinse agent are added to the interior of the dishwasher.

The present invention is also a kit for a dishwasher, said kit comprising: (a) an automatic dishwashing agent according to the embodiments of the present invention disclosed herein; and (b) instructions instructing the user to use the automatic dishwashing agent without adding a clear rinse agent and/or a water softener salt.

The automatic dishwashing agents according to the invention exhibit their advantageous cleaning and drying properties even in low-temperature cleaning methods. Preferred dishwashing methods using the agents according to the invention are therefore characterized in that the dishwasher methods are performed at a liquor temperature below 60° C., preferably below 50° C.

As described initially, the agents according to the invention are characterized by a reduced formation of deposits in comparison with traditional automatic dishwashing agents. Therefore, a method of preventing the formation of deposits on glass surfaces in automatic dishwashing by using an automatic dishwashing agent according to the invention is another embodiment of the present invention.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. A phosphate-free automatic dishwashing agent comprising:
a. 0.05 to 20 wt. % of an amphoteric polymer; and
b. 2 to 40 wt. % ethylene diamine disuccinic acid.

2. The agent of claim 1, wherein said amphoteric polymer is present from 0.05 to 5 wt. % based on the total weight of the agent.

3. The agent of claim 1, wherein said amphoteric polymer comprises at least one monomer selected from the group consisting of diallyl dimethylammonium salts, acrylamidopropyl trimethylammonium salts, and mixtures thereof.

4. The agent of claim 1, wherein said ethylene diamine disuccinic acid is present from 8.0 to 25 wt. % based on the total weight of the agent.

5. The agent of claim 1, further comprising a carbonate at a level of from 8.0 to 40 wt. % based on the total weight of the agent.

6. The agent of claim 1, further comprising a phosphonate at a level of from 1.5 to 4 wt. % based on the total weight of the agent.

7. The agent of claim 1, further comprising an anionic copolymer comprising: (i) at least one mono- or polyunsaturated carboxylic acid monomer; (ii) at least one mono- or polyunsaturated sulfonic acid monomer; and (iii) optionally at least one monomer selected from the group of ionic, nonionic, and mixtures thereof, said anionic copolymer present at from 2.5 to 10 wt. %, based on the total weight of the agent.

8. The agent of claim 1, further comprising an enzyme preparation at a level of from 0.5 to 8 wt. % based on the total weight of the agent.

9. The agent of claim 1, further comprising a nonionic surfactant at a level of from 1.0 to 6 wt. % based on the total weight of the agent.

10. The agent of claim 1 further comprising from 35 to 55 wt. % based on the total weight of the agent, wherein said agent is a liquid at ambient temperature.

11. The agent of claim 1 in the form of a multi-layered tablet.

12. A method for the cleaning of dishes in an automatic dishwasher, said method comprising the steps of:
a. placing said dishes in an automatic dishwasher equipped with a dishwashing program that includes a rinse cycle; and
b. dosing the agent of claim 1 into the interior of said dishwasher during its run through said dishwashing program, before the start of the main rinse cycle or in the course of the main rinse cycle,
wherein no additional water softener and no additional clear rinse agent are added to the interior of the dishwasher in the course of the cleaning.

13. The method of claim 12, wherein said agent is in the form of a multi-layered tablet.
